(19) United States
(12) Patent Application Publication
(10) Pub. No.: US 2015/0035870 A1
(43) Pub. Date: Feb. 5, 2015

(54) DISPLAY APPARATUS AND CONTROL METHOD FOR SAME

(71) Applicant: CANON KABUSHIKI KAISHA, Tokyo (JP)

(72) Inventor: Tsuyoshi Ooya, Atsugi-shi (JP)

(21) Appl. No.: 14/449,277

(22) Filed: Aug. 1, 2014

(30) Foreign Application Priority Data
Aug. 5, 2013 (JP) 2013-162586

(51) Int. Cl. G09G 3/34; G09G 3/36; G02F 1/1335

(52) U.S. Cl. CPC G09G 3/342; G02F 1/1336; G09G 3/36; G09G 2320/0233; G09G 2320/062; G09G 2320/0646
USPC 345/690; 345/102

(57) ABSTRACT

The display apparatus comprises: a light-emitting unit having a plurality of light sources; a display unit configured to display an image on a screen by modulating light from the light-emitting unit; a first storage unit configured to store a first brightness correction value corresponding to a first gradation level, and a second brightness correction value corresponding to a second gradation level; and a control unit configured to determine, by using the first brightness correction value and the second brightness correction value, a brightness correction value corresponding to a gradation level of a display object image data, and control, on the basis of the determined brightness correction value, the light emission brightnesses of respective light sources.

### BACKGROUND OF THE INVENTION

1. Field of the Invention

The present invention relates to a display apparatus and a control method for same.

2. Description of the Related Art

There are display apparatuses which have a light-emitting unit and a display unit (display panel) that displays an image on a screen by modulating the light from the light-emitting unit. Display apparatuses of this kind have a problem in that a brightness non-uniformity occurs within the screen.

There follows a description of a transmissive type liquid crystal display apparatus having a backlight and a liquid crystal panel which displays an image on a screen by transmitting light from the backlight.

Brightness non-uniformities occur in display apparatuses which have a light-emitting unit and a display unit, and do not only occur in liquid crystal display apparatuses. For example, brightness non-uniformities also occur in display apparatuses which use elements different to liquid crystal elements to modulate light from a light-emitting section.

(Tendency of Brightness Non-Uniformities)

Brightness non-uniformities tend to change with the level of the image data input to the liquid crystal panel (input signal level; gradation level). In particular, a brightness non-uniformity tends to become larger as the input signal level approach 0. For example, if the input signal level is high, then a brightness non-uniformity occurs which is greatly affected by fluctuation in the light transmission properties of the liquid crystal panel. If the input signal level becomes lower, then other effects become greater compared to the effect of the fluctuation in the light transmission properties of the panel, and the tendency of the brightness non-uniformity changes. The other effects described above are, for example, the effects of variation in the liquid crystal aperture ratio due to stress applied to the liquid crystal panel, and the like.

FIGS. 1A and 1B show examples of brightness non-uniformities. FIG. 1A shows one example of a brightness non-uniformity which occurs when the input signal level is high and FIG. 1B shows one example of a brightness non-uniformity which occurs when the input signal level is low. In FIGS. 1A and 1B, the brightness is represented by colors, in such a manner that the color becomes closer to white, the higher the display brightness (the brightness on the screen), and the color becomes closer to black, the lower the display brightness. If the input signal level is high, then as shown in FIG. 1A, for example, a brightness non-uniformity occurs in which the display brightness decreases in the edge portions of the screen. If the input signal level is low, then as shown in FIG. 1B, for example, a brightness non-uniformity occurs in which the display brightness increases in the edge portions of the screen.

(First Non-Uniformity Reduction Method and Problems)

As a method for reducing the brightness non-uniformities described above, a method has been proposed in which brightness non-uniformities are reduced by image processing (Japanese Patent Application Publication No. 2001-343954, and Japanese Patent Application Publication No. 2000-284773).

However, with a method for this kind, the contrast of the image is reduced.

The reasons for this are now described with reference to FIG. 2. FIG. 2 shows one example of a brightness distribution along the line 11 in FIGS. 1A and 1B (distribution of display brightness). The horizontal axis in FIG. 2 indicates a horizontal-direction position on the screen and the vertical axis indicates the display brightness. Here, it is supposed that the input signal level can take values in a range from 0 to 255. The brightness distribution 31 in FIG. 2 is a brightness distribution when displaying a uniform image where the input gradation level is 255. In the brightness distribution 31, the display brightness is decreased in the edge portions of the screen. The brightness distribution 32 in FIG. 2 is a brightness distribution when displaying a uniform image where the input gradation level is 0. In the brightness distribution 32, the display brightness is increased in the edge portions of the screen.

If the range of values which can be taken by the input signal level is left unchanged at 0 to 255, before and after image processing, then the input gradation level cannot be raised to a value higher than 255. Consequently, in order to reduce the brightness non-uniformity in the brightness distribution 31, the input gradation level must be lowered. More specifically, in order to achieve a uniform display brightness throughout the whole screen, the input gradation level of the other pixels must be lowered in such a manner that the differential in the display brightness with respect to the pixels having lowest display brightness becomes 0. When image processing of this kind is carried out, the brightness distribution 31 is corrected to the brightness distribution 33.

Similarly, it is not possible to reduce the input gradation level to a value lower than 0. Consequently, in order to reduce the brightness non-uniformity in the brightness distribution 32, the input gradation level must be raised. More specifically, in order to achieve a uniform display brightness throughout the whole screen, the input gradation level of the other pixels must be raised in such a manner that the differential in the display brightness with respect to the pixels having highest display brightness becomes 0. When image processing of this kind is carried out, the brightness distribution 32 is corrected to the brightness distribution 34.

The contrast is the ratio between the maximum value (maximum brightness) and the minimum value (smallest brightness) of the values taken by the display brightness. As shown in FIG. 2, by reducing the brightness non-uniformity, the maximum brightness is reduced and the smallest brightness is raised, and consequently the contrast is reduced.

(Second Non-Uniformity Reduction Method and Problems)

By controlling the light emission brightnesses of the respective light sources through using a backlight having a plurality of light sources as the backlight of the liquid crystal display apparatus, it is possible to reduce the brightness non-uniformity. The light emission brightness is controlled by controlling the value (pulse amplitude) of the voltage (or current) supplied to the light source, and the supply time (pulse width) thereof, for example. FIG. 3 shows one example of an arrangement of the plurality of light sources described above. The plurality of light sources are provided on the rear surface side of a liquid crystal panel, and the light emitted from the plurality of light sources is radiated onto the rear surface of the liquid crystal panel. In FIG. 3, region 41 denotes the region of the screen, and region 43 denotes a divided region. In the example in FIG. 3, a light source is provided for each of the divided regions 43. Furthermore, in the example in FIG. 3, a plurality of light-emitting members (LEDs 42) are arranged as one light source, and the light emission brightness of the plurality of LEDs 42 provided in a divided region 43 is controlled respectively and independently in each divided region 43.

There are also cases where one LED (light-emitting member) is used as one light source and the light emission brightness of each light-emitting member is controlled independently.

However, in a method of this kind, there may be increase in brightness non-uniformities, depending on the input signal level.

The reasons for this are now described with reference to FIG. 4. As shown in FIG. 4, it is possible to reduce the brightness non-uniformity of the brightness distribution 31 without lowering the maximum brightness (the maximum value that can be taken by the display brightness), by raising the light emission brightness in the edge portions of the screen. More specifically, it is possible to correct the brightness distribution 31 to the brightness distribution 51 by raising the light emission brightness in the edge portions of the screen.

However, when the light emission brightness is controlled in this way, since the light emission brightness in the edge portions of the screen is high, then the brightness distribution 32 becomes the brightness distribution 52, and hence the brightness non-uniformity increases.

(Third Non-Uniformity Reduction Method and Problems)

A method for resolving the abovementioned problem in the second method for reducing non-uniformities is described, for example, in Japanese Patent Application Publication No. 2009-128733. In the method described in Japanese Patent Application Publication No. 2009-128733, the brightness non-uniformity that occurs when the input signal level is high (first brightness non-uniformity) and the brightness non-uniformity that occurs when the input signal level is low (second brightness non-uniformity) are measured respectively. The light emission brightnesses of the light sources are then control led by using correction coefficients calculated using these measurement results.

However, in the method described in Japanese Patent Application Publication No. 2009-128733, it is not possible to sufficiently reduce the brightness non-uniformity if the tendency of the first brightness non-uniformity differs greatly from the tendency of the second brightness non-uniformity.

More specifically, in the method described in Japanese Patent Application Publication No. 2009-128733, the correction coefficient used is obtained by normalizing the reciprocal of the measured display brightness in such a manner that the correction coefficient of a reference pixel becomes a predetermined value. For example, if the brightness distribution when the input signal level is high (first brightness non-uniformity) is the brightness distribution 31 in FIG. 2, and the brightness distribution when the input signal level is low (second brightness non-uniformity) is the brightness distribution 32 in FIG. 2, then the distribution of the correction coefficient will be the distribution shown in FIG. 5. FIG. 5 shows one example of a coefficient distribution along the line 11 in FIGS. 1A and 1B (distribution of correction coefficient). The horizontal axis in FIG. 5 indicates a horizontal-direction position (horizontal position) on the screen and the vertical axis indicates the correction coefficient. The coefficient distribution 61 is the distribution of the correction coefficient (first correction coefficient) which is calculated on the basis of the first brightness non-uniformity, and the coefficient distribution 62 is the distribution of the correction coefficient (second correction coefficient) which is calculated on the basis of the second brightness non-uniformity.

In the method described in Japanese Patent Application Publication No. 2009-128733, a final coefficient (final correction coefficient) is calculated and used, by weighted summing of the first correction coefficient and the second correction coefficient using a previously established weighting, or by multiplying the second correction coefficient by the first correction coefficient. In other words, in the method described in Japanese Patent Application Publication No. 2009-128733, a uniform value is obtained at all times as the final coefficient, regardless of the input signal level. The final coefficient distribution 71 indicates the distribution of the final coefficient, which is a value obtained by multiplying the first correction coefficient by the second correction coefficient. In the example shown in FIG. 5, the final coefficient is a uniform value (1), irrespective of the horizontal position. Therefore, in the method described in Japanese Patent Application Publication No. 2009-128733, although the problem of increase in the second brightness non-uniformity due to reduction in the first brightness non-uniformity can be resolved, it is not possible to reduce both the first brightness non-uniformity and the second brightness non-uniformity sufficiently.

### SUMMARY OF THE INVENTION

The present invention provides technology whereby brightness non-uniformities can be reduced accurately, while suppressing reduction of image contrast.

The present invention in its first aspect provides a display apparatus, comprising:

a light-emitting unit having a plurality of light sources, the light emission brightness of which can be controlled independently;

a display unit configured to display an image on a screen by modulating light from the light-emitting unit;

a first storage unit configured to store a first brightness correction value for reducing a first brightness non-uniformity of the display unit corresponding to a first gradation level, and a second brightness correction value for reducing a second brightness non-uniformity of the display unit corresponding to a second gradation level; and

a control unit configured to determine, by using the first brightness correction value and the second brightness correction value stored in the first storage unit, a brightness correction value corresponding to a gradation level of a display object image data, and control, on the basis of the determined brightness correction value, the light emission brightnesses of respective light sources.

The present invention in its second aspect provides a method for controlling a display apparatus, having:

a light-emitting unit having a plurality of light sources, the light emission brightness of which can be controlled independently;

a display unit configured to display an image on a screen by modulating light from the light-emitting unit; and

a first storage unit configured to store a first brightness correction value for reducing a first brightness non-uniformity of the display unit corresponding to a first gradation level, and a second brightness correction value for reducing a second brightness non-uniformity of the display unit corresponding to a second gradation level;

the control method comprising:

determining, by using the first brightness correction value and the second brightness correction value stored in the first storage unit, a brightness correction value corresponding to a gradation level of a display object image data; and

controlling the light emission brightnesses of respective light sources, on the basis of the determined brightness correction value.

The present invention in its third aspect provides a non-transitory computer readable medium that stores a program, wherein the program causes a computer to execute the method.

According to the present invention, it is possible to reduce brightness non-uniformities accurately, while suppressing reduction of image contrast.

Further features of the present invention will become apparent from the following description of exemplary embodiments with reference to the attached drawings.

### BRIEF DESCRIPTION OF THE DRAWINGS

FIGS. 1A and 1B are diagrams showing examples of brightness non-uniformities;

FIG. 2 is a diagram showing an example of a conventional method for reducing brightness non-uniformities;

FIG. 3 is a diagram showing an example of the composition of a backlight;

FIG. 4 is a diagram showing an example of a conventional method for reducing brightness non-uniformities;

FIG. 5 is a diagram showing an example of a conventional coefficient distribution;

FIG. 6 is a block diagram showing one example of the functional composition of a liquid crystal display apparatus relating to a first embodiment of the invention;

FIGS. 7A and 7B are diagrams showing examples of the average display brightness and the distribution of the first brightness correction value;

FIGS. 8A and 8B are diagrams showing examples of the average display brightness and the distribution of the second brightness correction value;

FIG. 9 is a diagram showing an example of input image data;

FIG. 10 is a diagram showing an example of a brightness non-uniformity;

FIGS. 11A and 11B are diagrams showing examples of characteristic values and final brightness correction values relating to the first embodiment;

FIGS. 12A and 12B are diagrams showing examples of final brightness correction values relating to the first embodiment;

FIGS. 13A and 13B are diagrams showing examples of the backlight brightness distribution and display image, relating to the first embodiment;

FIG. 14 is a block diagram showing one example of the functional composition of a liquid crystal display apparatus relating to a second embodiment of the invention; and

FIGS. 15A and 15B are diagrams showing examples of level correction values relating to the second embodiment.

### DESCRIPTION OF THE EMBODIMENTS

Below, a display apparatus and a control method for same relating to an embodiment of the present invention will be described.

In the present embodiment, an example is described, in which the display apparatus is a transmissive liquid crystal display apparatus, but the display apparatus is not limited to being a transmissive liquid crystal display apparatus. The display apparatus may be any display apparatus having an independent light source. For example, the display apparatus may be reflective liquid crystal display apparatus. Furthermore, the display apparatus may be a display using a micro electro mechanical system (MEMS) shutter method which employs a MEMS shutter, rather than liquid crystal elements.

### First Embodiment

### General Composition

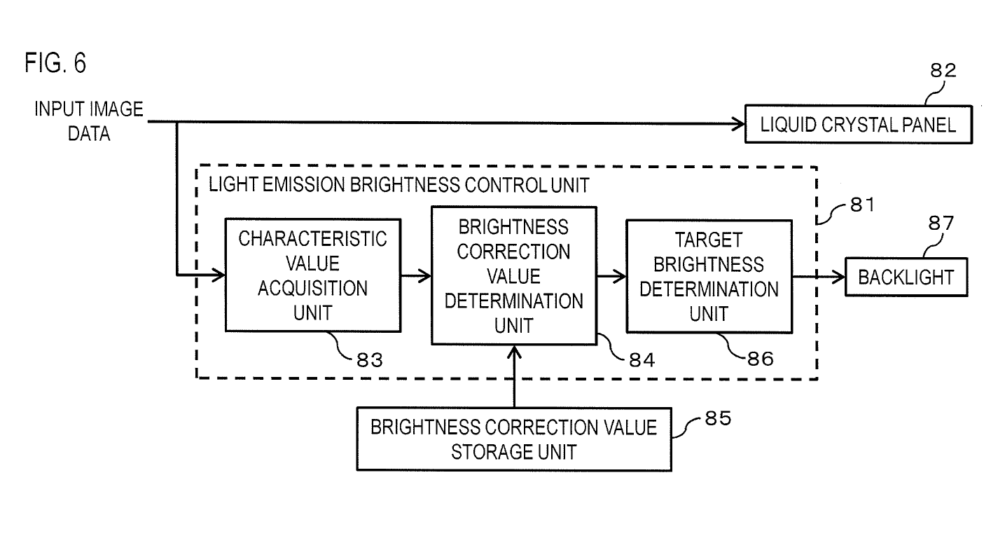

FIG. 6 is a block diagram showing one example of the functional composition of a liquid crystal display apparatus relating to a first embodiment of the present invention.

The backlight 87 is a light-emitting unit having a plurality of light sources of which the light emission brightness can be controlled independently. The plurality of light sources are provided on the rear surface side of a liquid crystal panel 82, and the light emitted from the backlight 87 (plurality of light sources) is radiated onto the rear surface of the liquid crystal panel 82. The light source has one or more light-emitting members. For the light-emitting member, it is possible to use an LED, an organic EL element, a cold cathode tube, or the like.

In the present embodiment, as shown in FIG. 3, light sources are provided respectively in each of the plurality of divided regions which constitute the screen region. In FIG. 3, region 41 denotes the region of the screen, and region 43 denotes a divided region.

Furthermore, in the present embodiment, as shown in FIG. 3, four LEDs 42 are arranged as one light source, and the light emission brightness of the four LEDs 42 provided in a divided region 43 is controlled respectively and independently in each divided region 43.

Furthermore, in the present embodiment, the light emission brightness is control led by controlling the supply time (pulse width) of the voltage (or current) supplied to the light sources (pulse width modulation). The method for controlling the light emission brightness is not limited to this. For example, the light emission brightness may be controlled by controlling the value (pulse amplitude) of the voltage (or current) supplied to the light source (pulse amplitude modulation). The light emission brightness may be controlled by controlling both the pulse amplitude and the pulse width of the voltage (or current) supplied to the light sources.

The liquid crystal panel 82 is a display unit which displays an image on the screen by modulating light from the backlight 87. More specifically, the liquid crystal panel 82 has a plurality of liquid crystal elements, and controls the transmissivity of the respective liquid crystal elements on the basis of the image data. An image is displayed by means of light from the backlight 87 being transmitted by the respective liquid crystal elements.

In the present embodiment, the image data input to the display apparatus (input image data) is input to the liquid crystal panel 82, and the transmissivity is controlled in accordance with the input image data, but the invention is not limited to this. For example, predetermined image processing may be applied to the input image data, and the image data may be input to the liquid crystal panel 82 after the predetermined image processing. The transmissivity may be controlled in accordance with the image data after the predetermined image processing. The predetermined image processing is, for example, edge emphasis processing, blur processing, interpolated pixel generation processing, compensation processing for compensating for change in the display brightness due to change in the light emission brightness, and the like.

Furthermore, the liquid crystal panel 82 has the following characteristics.

Characteristics whereby a first brightness non-uniformity occurs when a uniform image of a first gradation level is displayed in a state where the plurality of light sources are emitting light at the same light emission brightness

Characteristics whereby a second brightness non-uniformity, which has a different tendency to the first brightness non-uniformity, occurs when a uniform image of a second gradation level, which is lower than the first gradation level, is displayed in a state where the plurality of light sources are emitting light at the same light emission brightness

In the present embodiment, an example is described in which the gradation level is a pixel value that is different from the brightness level of the image data, but the gradation level may also be brightness level of the image data.

In the present embodiment, the first gradation level is the maximum value of the gradation level that may be taken by the image data, and the second gradation level is the minimum value of the gradation level that may be taken by the image data. More specifically, the gradation level that may be taken by the image data is a value no less than 0 and no greater than 255, the first gradation level is 255 and the second gradation level is 0. However, the first gradation level and the second gradation level are not limited to these. The first gradation level may be a value lower than the maximum value of the gradation level that may be taken by the image data. The second gradation level may be a value higher than the minimum value of the gradation level that may be taken by the image data. If the second gradation level is lower than the first gradation level, then the first gradation level and the second gradation level may be any values.

The light emission brightness control unit 81 controls the light emission brightnesses of the respective light sources in accordance with the brightness (luminance) of the image that is to be displayed in the regions of the screen corresponding respectively to the plurality of light sources.

In the present embodiment, a plurality of divided regions which constitute the screen region are set as the plurality of regions corresponding to the plurality of light sources, but the invention is not limited to this. For example, it is also possible to set, as the region corresponding to alight source, a region overlapping with a region corresponding to another light source, or a region that does not contact a region corresponding to another light source.

Furthermore, in the present embodiment, a plurality of mutually different divided regions are set as the plurality of regions corresponding to the plurality of light sources, but the invention is not limited to this. For example, it is also possible to set, as a region corresponding to a light source, a region that is the same as the region corresponding to another light source.

The brightness correction value storage unit 85 is a first storage unit in which a first brightness correction value and a second brightness correction value for each light source are previously recorded. The first brightness correction value is a brightness correction value for correcting the predetermined reference value to a target brightness (a target value of the light emission brightness of the light source) for reducing the first brightness non-uniformity. The second brightness correction value is a brightness correction value for correcting the predetermined reference value to a target brightness for reducing the second brightness non-uniformity.

In the present embodiment, an example is described in which the brightness correction value is a correction coefficient that is multiplied by the predetermined reference value, but the brightness correction value is not limited to this. For example, the brightness correction value may also be a correction value that is added to the predetermined reference value.

(Light Emission Brightness Control Unit)

As shown in FIG. 6, the light emission brightness control unit 81 includes a characteristic value acquisition unit 83, a brightness correction value determination unit 84, a target brightness determination unit 86, and the like.

The characteristic value acquisition unit 83 acquires, for each of the plurality of light sources, a characteristic value which represents the brightness of the image that is to be displayed on the region of the screen corresponding to that light source, and outputs the acquired characteristic value to the brightness correction value determination unit 84. In the present embodiment, the plurality of light sources and the plurality of regions (divided regions) correspond in a one-to-one relationship. Therefore, the processing described above in the characteristic value acquisition unit 83 can be regarded as “processing for acquiring a characteristic value respectively for each of the plurality of regions (divided regions) corresponding to the plurality of light sources, and outputting the acquired characteristic values to the brightness correction value determination unit 84”. The characteristic value is a “characteristic value acquired in respect of a light source”, and might also be called a “characteristic value acquired in respect of a region corresponding to a light source”.

The characteristic value is, for example, a representative value or histogram of the pixel values in the image data representing the image that is to be displayed in the divided region, or a representative value or histogram of the brightness level of image data representing the image that is to be displayed in the divided region. The representative value is, for example, a maximum value, a minimum value, a most common value, an average value, an intermediate value, or the like. In the present embodiment, the average brightness level (ABL) of the image data representing the image that is to be displayed on a divided region is acquired as a characteristic value.

In the present embodiment, the characteristic value is acquired from the input image data, but the invention is not limited to this. For example, the characteristic value may also be acquired from an external source. More specifically, the characteristic value may be appended to the image data, as metadata.

The brightness correction value determination unit 84 acquires, from the brightness correction value storage unit 85, the first brightness correction value and the second brightness correction value for each light source (each divided region), and acquires the characteristic value for each light source, from the characteristic value acquisition unit 83. The brightness correction value determination unit 84 determines, for each light source, a brightness correction value (final brightness correction value) which synthesizes the first brightness correction value and the second brightness correction value for that light source, on the basis of the characteristic value acquired in respect of the light source. The brightness correction value determination unit 84 then outputs the final brightness correction value thus determined to the target brightness determination unit 86.

In the present embodiment, the final brightness correction value is calculated by weighted synthesis of the first brightness correction value and the second brightness correction value, but the invention is not limited to this. For example, the final brightness correction value may be determined from a combination of the first brightness correction value and the second brightness correction value, by using a table which represents associations between combinations of the first brightness correction value and the second brightness correction value, and final brightness correction values.

The target brightness determination unit 86 determines the target brightness for each light source. The target brightness determination unit 86 controls the light emission brightnesses of the light sources, to the respective target brightnesses. In the present embodiment, a value obtained by multiplying the predetermined reference value by the final brightness correction value of the light source is determined as the target brightness of the light source. Therefore, the light emission brightness of a light source having a final brightness correction value of 0.5 is controlled to a target brightness which is half the predetermined reference value, and the light emission brightness of a light source having a final brightness correction value of 2.0 is controlled to a target brightness of two times the predetermined reference value.

The predetermined reference value may be any value.

(Method for Determining First Brightness Correction Value and Second Brightness Correction Value)

A concrete example of a method for determining the first brightness correction value will now be described.

Firstly, in a state where a plurality of light sources are emitting light at the same light emission brightness (predetermined reference value), a uniform image of a first gradation level is displayed on the display apparatus. In other words, by causing the light sources to emit light using 1.0 as the final brightness correction value for each light source, and inputting, to the liquid crystal panel 82, image data wherein the gradation level is 255 for all of the pixels, an image is displayed on the display apparatus.

Next, the brightness distribution of the display image (the image that is displayed on the screen) is measured, using a two-dimensional brightness measurement apparatus. The brightness distribution measured here represents the first brightness non-uniformity.

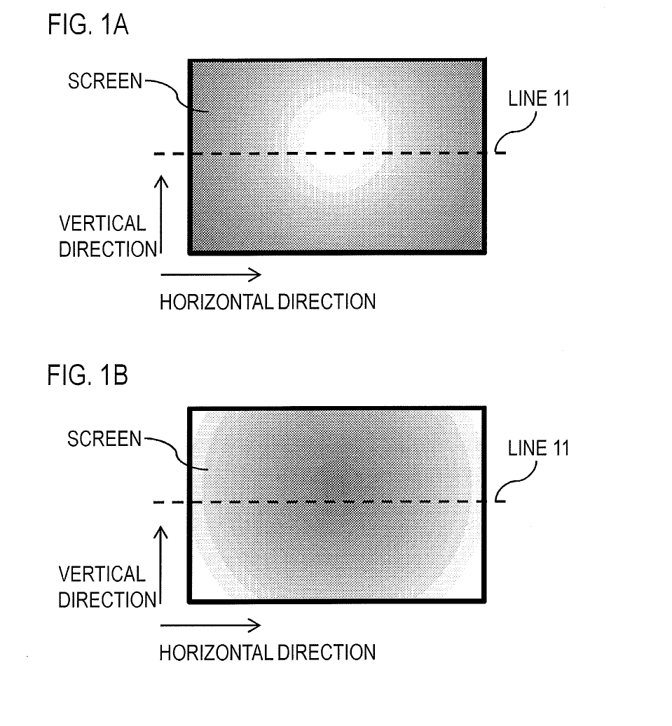

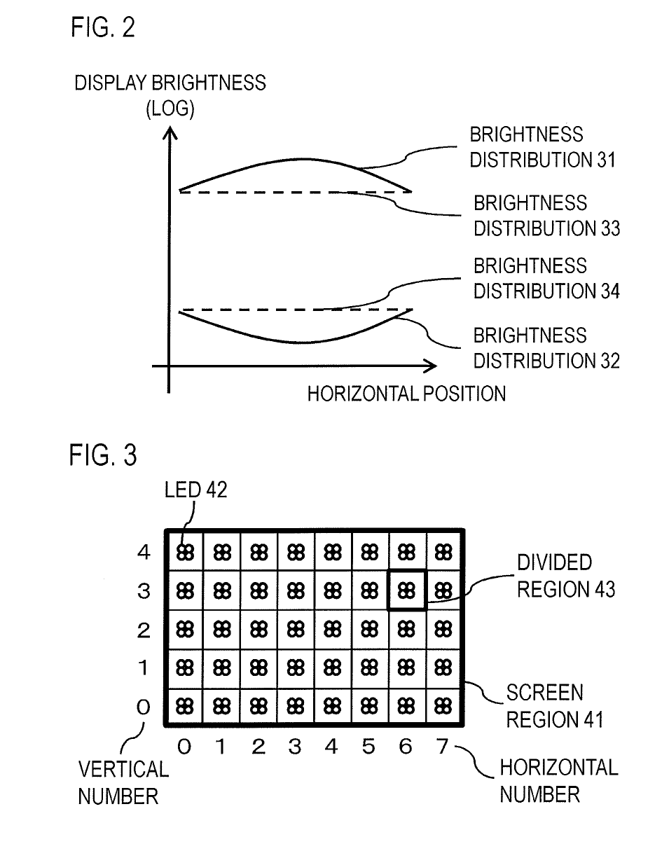

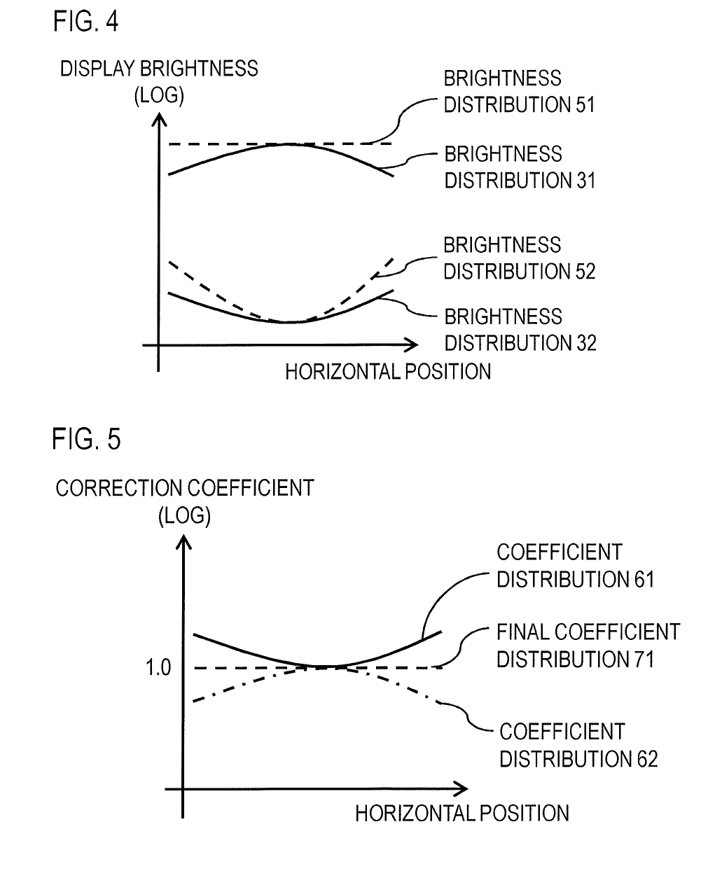

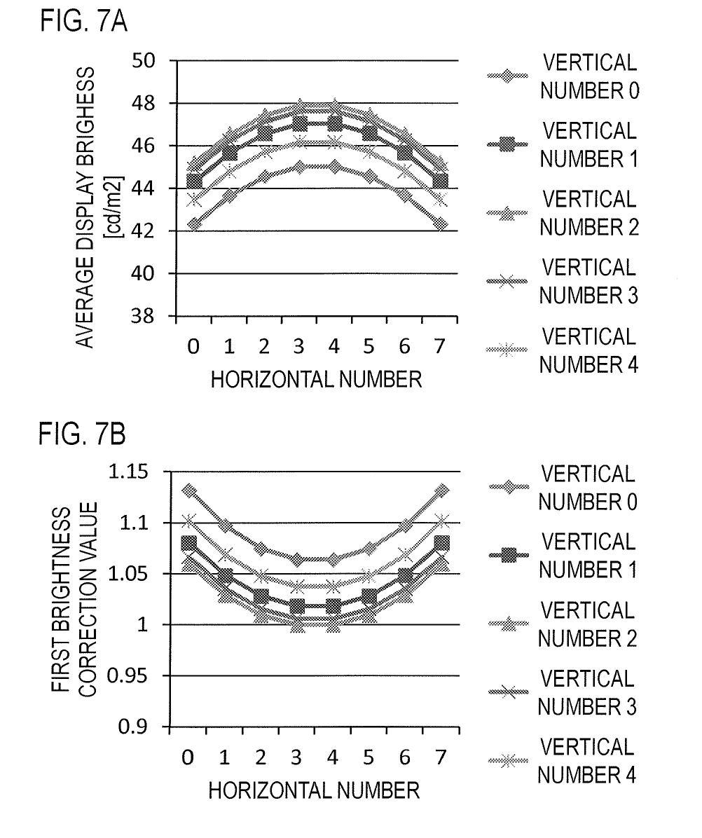

For each light source, a display brightness characteristic value representing the display brightness in the divided region corresponding to that light source is acquired from the measured brightness distribution. The display brightness characteristic value is a representative value or histogram of the display brightness in the divided region. In the present embodiment, an average value of the display brightness in the divided region (average display brightness) is acquired as the display brightness characteristic value. Furthermore, in the present embodiment, as shown in FIG. 3, horizontal numbers (0 to 7) which are numbers representing the position in the horizontal direction (horizontal position) of the light source (divided region), and vertical numbers (0 to 4) representing the position in the vertical direction (vertical direction) of the light source, are determined in advance. Therefore, a process of selecting a light source by designating a horizontal number and a vertical number, and acquiring the display brightness characteristic value corresponding to the selected light source, is carried out successively for each of the plurality of light sources. FIG. 7A shows the distribution of the display brightness characteristic value (average display brightness) when the brightness distribution shown in FIG. 1A was measured. In FIG. 1A, the brightness is represented by colors, in such a manner that the color becomes closer to white, the higher the display brightness, and the color becomes closer to black, the lower the display brightness.

Next, the first brightness correction value of the light source is determined for each light source, on the basis of the display brightness characteristic value acquired in respect of that light source. In the present embodiment, the first brightness correction value is calculated by using Formula 1 below. In Formula 1, M1 (h, v) is a display brightness characteristic value which is acquired in respect of a light source having a horizontal number h and a vertical number v. M1max is a maximum value of the plurality of display brightness characteristic values acquired in respect of a plurality of light sources. C1 (h, v) is the first brightness correction value of the light source having a horizontal number h and a vertical number v. FIG. 7B shows the distribution of the first brightness correction value when calculated from the display brightness characteristic value shown in FIG. 7A.

C1(h,v)=M1max/M1(h,v) (Formula 1)

A concrete example of a method for determining the second brightness correction value will now be described.

The second brightness correction value is determined by a method similar to that of the first brightness correction value.

Firstly, in a state where a plurality of light sources are emitting light at the same light emission brightness (predetermined reference value), a uniform image of a second gradation level is displayed on the display apparatus. In other words, by causing the light sources to emit light using 1.0 as the final brightness correction value for each light source, and inputting, to the liquid crystal panel 82, image data wherein the gradation level is 0 for all of the pixels, an image is displayed on the display apparatus.

Next, the brightness distribution of the display image is measured using a two-dimensional brightness measurement apparatus. The brightness distribution measured here represents the second brightness non-uniformity.

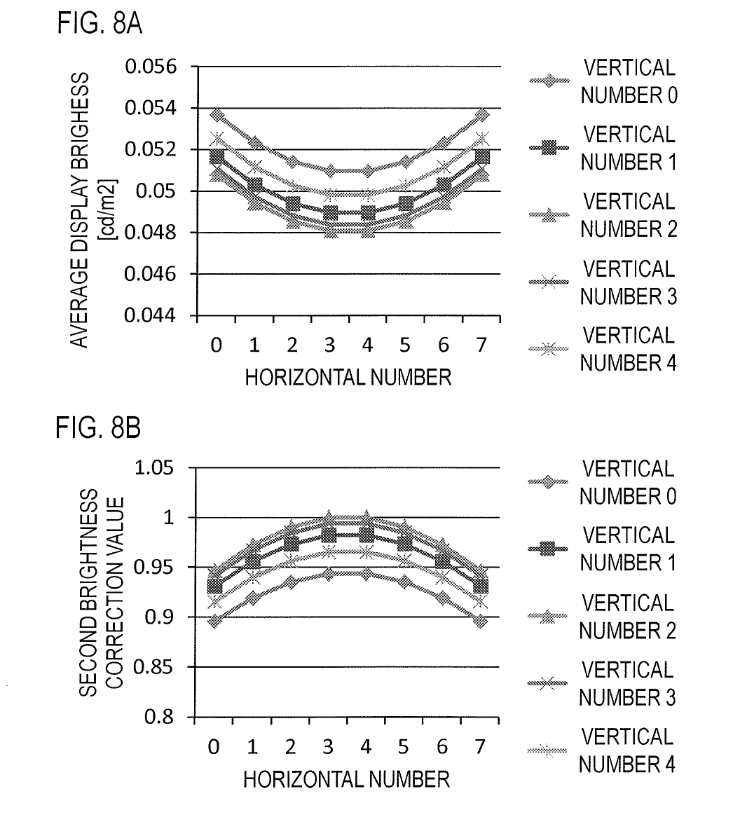

For each light source, a display brightness characteristic value corresponding to that light source is acquired from the measured brightness distribution. FIG. 8A shows the distribution of the display brightness characteristic value (average di splay brightness) when the brightness distribution shown in FIG. 1B was measured.

Next, the second brightness correction value of the light source is determined for each light source, on the basis of the display brightness characteristic value acquired in respect of that light source. In the present embodiment, the second brightness correction value is calculated by using Formula 2 below. In Formula 2, M2 (h, v) is a display brightness characteristic value which is acquired in respect of a light source having a horizontal number h and a vertical number v. M2 min is a minimum value of the plurality of display brightness characteristic values acquired in respect of a plurality of light sources. C2(h,v) is the second brightness correction value of the light source having a horizontal number h and a vertical number v. FIG. 8B shows the distribution of the second brightness correction value when calculated from the display brightness characteristic value shown in FIG. 8A.

C2(h,v)=M2min/M2(h,v) (Formula 2)

In the present embodiment, the first brightness correction value and the second brightness correction value determined by the method indicated above are recorded in advance in the brightness correction value storage unit 85.

(Method for Acquiring Characteristic Value)

A concrete example of the method for acquiring a characteristic value by the characteristic value acquisition unit 83 will now be described.

Firstly, the characteristic value acquisition unit 83 extracts, for each light source, image data of the image that is to be displayed on the region corresponding to the light source, from the input image data. In other words, the input image data is divided into image data for each light source (divided region).

Next, the characteristic value acquisition unit 83 acquires, for each light source, a characteristic value for the light source, from the image data corresponding to the light source. More specifically, for each light source, an average brightness level (ABL) of the image data for the light source is calculated as the characteristic value corresponding to that light source. If the gradation level and the brightness level have a 2.2 gamma value relationship, then ABL is calculated by using Formula 3 below. In Formula 3, L(x,y) is the gradation level of the pixel when the horizontal position is x and the vertical position is y. S represents all of the pixels in the region corresponding to the light source that is the object of calculating ABL.

$$\begin{matrix}[ Expression 1 ] & \\ A B L = \frac{{\sum }_{S} {( L ( x , y ) / 255 )}^{22}}{{\sum }_{S} 1} & ( Formula 3 )\end{matrix}$$

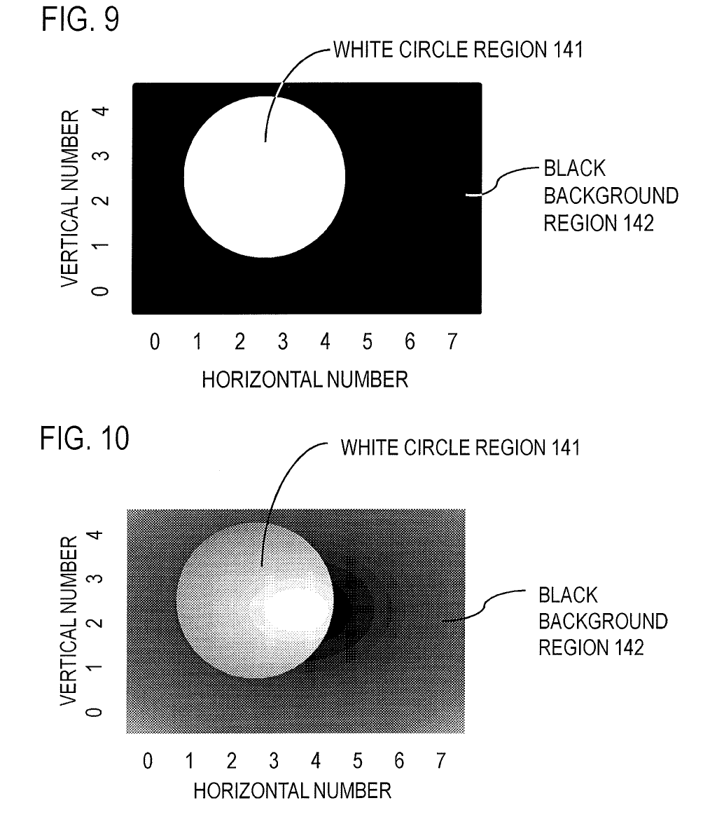

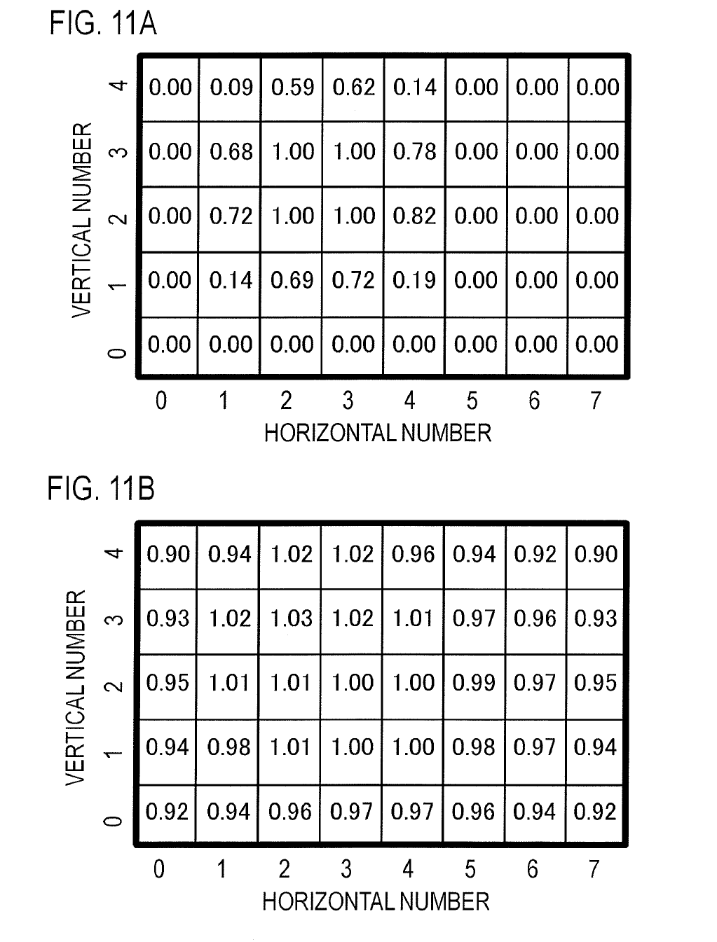

An example is described here in which the input image data is image data representing the image shown in FIG. 9 (an image where a white circle is present on a black background). In the white circle region 141 which is the region of the white circle in the region of the image shown in FIG. 9, the gradation level is 255, and in the black background region 142 which is the region of the black background, the gradation level is 0. In this case, the ABL value of each divided region (each light source) which is acquired as a characteristic value by the characteristic value acquisition unit 83 is the value shown in FIG. 11A.

(Method for Determining Target Brightness)

A concrete example of a method for determining the target brightness will now be described.

When the image shown in FIG. 9 is displayed in a state where the plurality of light sources are emitting light at the same light emission brightness, a display image containing a brightness non-uniformity is obtained as shown in FIG. 10. More specifically, in the white circle region 141, a first brightness non-uniformity occurs in which the display brightness declines as the distance increases from the center of the screen, and in the black background region 142, a second brightness non-uniformity occurs in which the display brightness rises as the distance increases from the center of the screen. Therefore, in the present embodiment, the target brightness is determined in such a manner that the first brightness non-uniformity is reduced in respect of light sources for which a characteristic value corresponding to the first gradation level is acquired. Furthermore, the target brightness is determined in such a manner that the second brightness non-uniformity is reduced in respect of light sources for which a characteristic value corresponding to the second gradation level is acquired. Below, a target brightness for reducing the first brightness non-uniformity is called the first target brightness and a target brightness for reducing the second brightness non-uniformity is called the second target brightness.

Moreover, in the present embodiment, a target brightness between the first target brightness and the second target brightness is determined in respect of light sources for which a characteristic value corresponding to a gradation level between the first gradation level and the second gradation level is acquired.

Consequently, it is possible to reduce the brightness non-uniformity described above.

The first brightness non-uniformity and the second brightness non-uniformity are not limited to the brightness non-uniformities described above. Provided that the tendencies of the first brightness non-uniformity and the second brightness non-uniformity are different, the first brightness non-uniformity and the second brightness non-uniformity may be any brightness non-uniformity.

The brightness correction value determination unit 84 calculates a final brightness correction value by using Formula 4 below. In Formula 4, Ch(h,v) is a characteristic value which is acquired in respect of a light source having a horizontal number h and a vertical number v. Cf(h,v) is the final brightness correction value of the light source having a horizontal number h and a vertical number v.

Cf(h,v)=C1(h,v)×Ch(h,v)+C2(h,v)×(1.0−Ch(h,v)) (Formula 4)

The calculation formula for the final brightness correction value is not limited to Formula 4. The calculation formula for the final brightness correction value can be determined (selected) on the basis of the characteristics of the liquid crystal panel (display unit) of the display apparatus.

The target brightness determination unit 86 determines the target brightness of the light source by multiplying the final brightness correction value of the light source by the predetermined reference value, for each of the light sources. The target brightness determination unit 86 controls the light emission brightnesses of the light sources, to the respective target brightnesses.

According to Formula 4, a value resulting from synthesizing the first brightness correction value and the second brightness correction value by weighting based on the characteristic value is obtained as the final brightness correction value. As a result of this, a target brightness obtained by synthesizing the first target brightness and the second target brightness by a weighting based on the characteristic value is determined.

Furthermore, according to Formula 4, the higher the brightness represented by the acquired characteristic value, the greater the weighting of the first brightness correction value. More specifically, in the present embodiment, a characteristic value having a larger value is acquired, the higher the brightness of the image. Consequently, in Formula 4, the higher the value of the acquired characteristic value, the greater the weighting of the first brightness correction value. Consequently, the higher the brightness represented by the acquired characteristic value, the greater the weighting of the first target brightness.

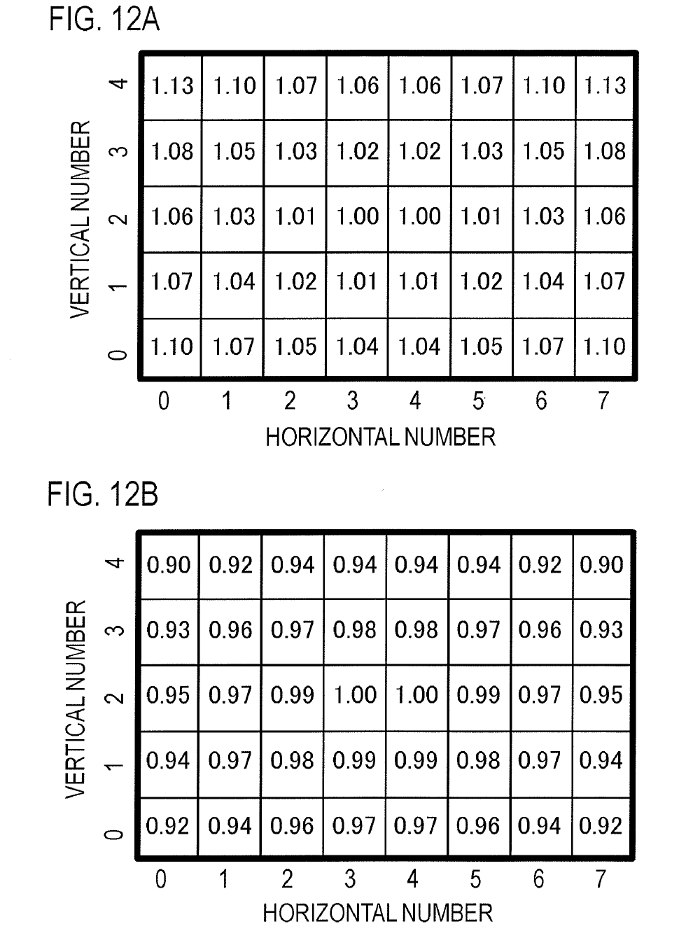

The first brightness correction value is used as the final brightness correction value and the first target brightness is determined as the target brightness, for light sources for which a characteristic value corresponding to the first gradation level has been acquired. For example, if the gradation level of all of the pixels in the input image data is a first gradation level (255), then the characteristic value of the respective divided regions (the respective light sources) is 1.0 in each case, and the final brightness correction values for each divided region (each light source) are the values shown in FIG. 12A. The values shown in FIG. 12A are the same values as the first brightness correction values which are shown in FIG. 7B. As a result of this, the first target brightness is determined as a target brightness for all of the light sources, and a display image free from brightness non-uniformities can be obtained. When displaying an all-white image, for example, the light emission brightness is controlled in such a manner that the light emitted from the backlight 87 (the backlight light) is the reciprocal of the first brightness non-uniformity (the brightness non-uniformity of the light emitted from the screen (screen light)). Accordingly, the first brightness non-uniformity is cancelled out by the brightness non-uniformity in the backlight light, and an all-white display image free from brightness non-uniformities can be obtained.

Furthermore, the second brightness correction value is used as the final brightness correction value and the second target brightness is determined as the target brightness, for light sources for which a characteristic value corresponding to the second gradation level has been acquired. For example, if the gradation level of all of the pixels in the input image data is a second gradation level (0), then the characteristic value of the respective divided regions (the respective light sources) is 0.0 in each case, and the final brightness correction values for each divided region (each light source) are the values shown in FIG. 12B. The values shown in FIG. 12B are the same values as the second brightness correction values which are shown in FIG. 8B. As a result of this, the second target brightness is determined as a target brightness for all of the light sources, and a display image free from brightness non-uniformities can be obtained. For example, when displaying an all-black image, the light emission brightness is controlled in such a manner that the brightness non-uniformity of the backlight light is the reciprocal of the second brightness non-uniformity. Consequently, the second brightness non-uniformity is cancelled out by the brightness non-uniformity in the backlight light, and an all-black display image free from brightness non-uniformities can be obtained.

Moreover, a brightness correction value between the first brightness correction value and the second brightness correction value is used as the final brightness correction value in respect of light sources for which a characteristic value corresponding to a gradation level between the first gradation level and the second gradation level is acquired. A value between the first target brightness and the second target brightness is determined as the target brightness.

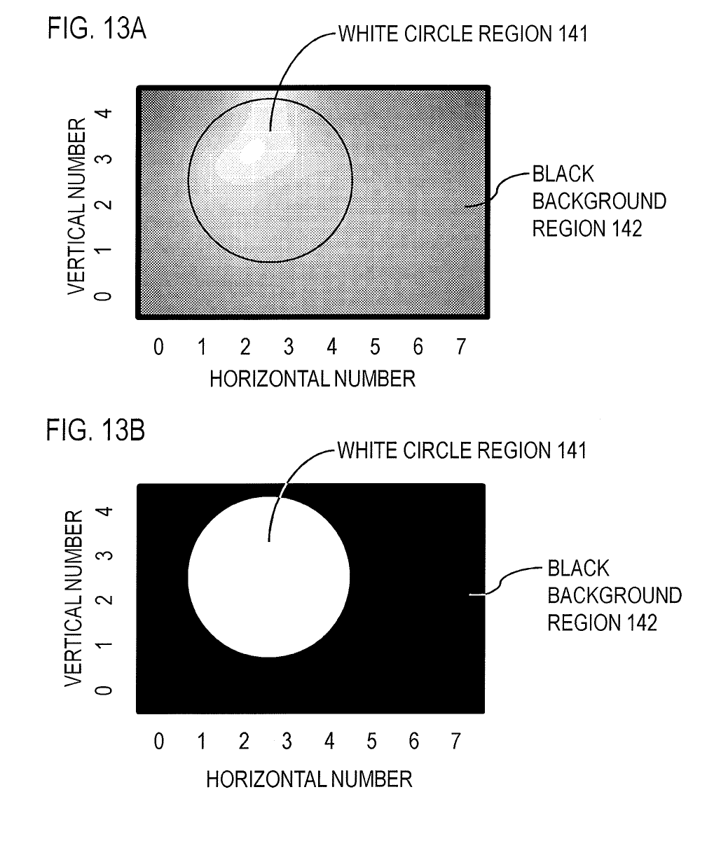

When displaying the image shown in FIG. 9 (when the characteristic values in FIG. 11A are acquired), the final brightness correction value for each divided region (each light source) is the value shown in FIG. 11B. When the light emission brightness is controlled using the final brightness correction values shown in FIG. 11B, then the brightness distribution of the backlight light is a distribution having a certain non-uniformity, as shown in FIG. 13A. As shown in FIG. 13A, in the present embodiment, the light emission brightness is controlled in such a manner that the brightness non-uniformity of the backlight light is the reciprocal of the brightness non-uniformity shown in FIG. 10 (the brightness non-uniformity of the screen light). More specifically, the light emission brightness is controlled in such a manner that, in the white circle region 141, the brightness of the backlight light rises as the distance from the center of the screen increases, and in the black background region 142, the brightness of the backlight light falls as the distance from the center of the screen increases. As a result of this, as shown in FIG. 13B, it is possible to obtain a display image which is free from both the first brightness non-uniformity and the second brightness non-uniformity. In other words, it is possible to obtain a display image which is free from the first brightness non-uniformity, in the white circle region 141, and it is possible to obtain a display image which is free from the second brightness non-uniformity, in the black background region 142.

As described above, according to the present embodiment, the brightness non-uniformities are reduced by controlling the light emission brightnesses of the light sources. Consequently, it is possible to reduce brightness non-uniformities without reducing the contrast of the image. Furthermore, according to the present embodiment, a target brightness corresponding to the gradation level is determined, and brightness non-uniformities can be reduced with high accuracy, compared to the prior art. In other words, the brightness non-uniformity of which the tendency changes with the gradation level can be reduced with higher accuracy than in the prior art.

In the present embodiment, an example is described in which the first target brightness is a target brightness that completely eliminates the first brightness non-uniformity, but the first target brightness is not limited to this. The first target brightness may be a target brightness which can reduce the first brightness non-uniformity, and does not have to be a target brightness that completely eliminates the first brightness non-uniformity. The same applies to the second target brightness.

In the present embodiment, a target brightness between the first target brightness and the second target brightness is determined in respect of light sources for which a characteristic value corresponding to a gradation level between the first gradation level and the second gradation level is acquired, but the invention is not limited to this. At the least, the first target brightness may be determined in respect of light sources for which a characteristic value corresponding to the first gradation level is acquired, and the second target brightness may be determined in respect of light sources for which a characteristic value corresponding to the second gradation level is acquired. Consequently, it is possible to reduce both the brightness non-uniformity in the region of the first gradation level (first brightness non-uniformity) and the brightness non-uniformity in the region of the second gradation level (second brightness non-uniformity).

Moreover, in the present embodiment, either the first target brightness or the second target brightness is determined in respect of light sources for which a characteristic value corresponding to a gradation level between the first gradation level and the second gradation level is acquired. Here, if a target brightness between the first target brightness and the second target brightness is determined in respect of light sources for which a characteristic value corresponding to a gradation level between the first gradation level and the second gradation level is acquired, then the brightness non-uniformity in a region of a gradation level of that kind can be reduced with higher accuracy.

In the present embodiment, a target brightness obtained by synthesizing the first target brightness and the second target brightness by a weighting based on the characteristic value is determined, but the invention is not limited to this. For example, the first target brightness may be determined as the target brightness in respect of light sources for which a characteristic value representing a brightness equal to or greater than a predetermined value is acquired, and the second target brightness may be determined as the target brightness in respect of light sources for which a characteristic value less than the predetermined value is acquired.

Furthermore, in the present embodiment, the higher the brightness represented by the acquired characteristic value, the greater the weighting of the first brightness correction value, but the invention is not limited to this. For example, it is possible to set a uniform weighting which is independent of the brightness represented by the acquired characteristic value, in respect of light sources for which a characteristic value corresponding to a gradation level between the first gradation level and the second gradation level is acquired. More specifically, the weighting of the first target brightness and the second target brightness may be set to the same value and the average value of the first target brightness and the second target brightness may be determined as the target brightness, in respect of light sources for which a characteristic value corresponding to a gradation level between the first gradation level and the second gradation level is acquired. It can be regarded that, the higher the brightness represented by the acquired characteristic value, the closer the generated brightness non-uniformity becomes to the first brightness non-uniformity, and the lower the brightness represented by the acquired characteristic value, the closer the generated brightness non-uniformity becomes to the second brightness non-uniformity. Therefore, if the weighting of the target brightness for reducing the first brightness non-uniformity is raised, the higher the brightness represented by the acquired characteristic value, then the brightness non-uniformity in the region of the gradation levels between the first gradation level and the second gradation level can be reduced with higher accuracy.

In the present embodiment, a first brightness correction value which corrects the predetermined reference value to a first target brightness, and a second brightness correction value which corrects the predetermined reference value to a second target brightness are used, but the invention is not limited to this. Since the first target brightness and the second target brightness are fixed values, the first target brightness and the second target brightness for each light source may be recorded in advance. Therefore, the target brightnesses for the light sources may be determined by using the first target brightness and the second target brightness of the respective light sources which are thus recorded.

### Second Embodiment

The second embodiment is described with respect to a case where the display unit (liquid crystal panel) also has the following characteristics.
Characteristics whereby a third brightness non-uniformity, which has a different tendency to the first brightness non-uniformity and the second brightness non-uniformity, occurs when a uniform image of a gradation level between the first gradation level and the second gradation level, is displayed in a state where the plurality of light sources are emitting light at the same light emission brightness.

If the gradation level is a gradation level between the first gradation level and the second gradation level, then contrast is not reduced, even if the gradation level is corrected in order to reduce the brightness non-uniformity. Consequently, the third brightness non-uniformity described above is effectively reduced by image processing (correction of the gradation level).

Therefore, in the present embodiment, an example is described in which, in addition to the processing in the first embodiment, processing for correcting the gradation level of the image data so as to reduce the third brightness non-uniformity is also carried out.

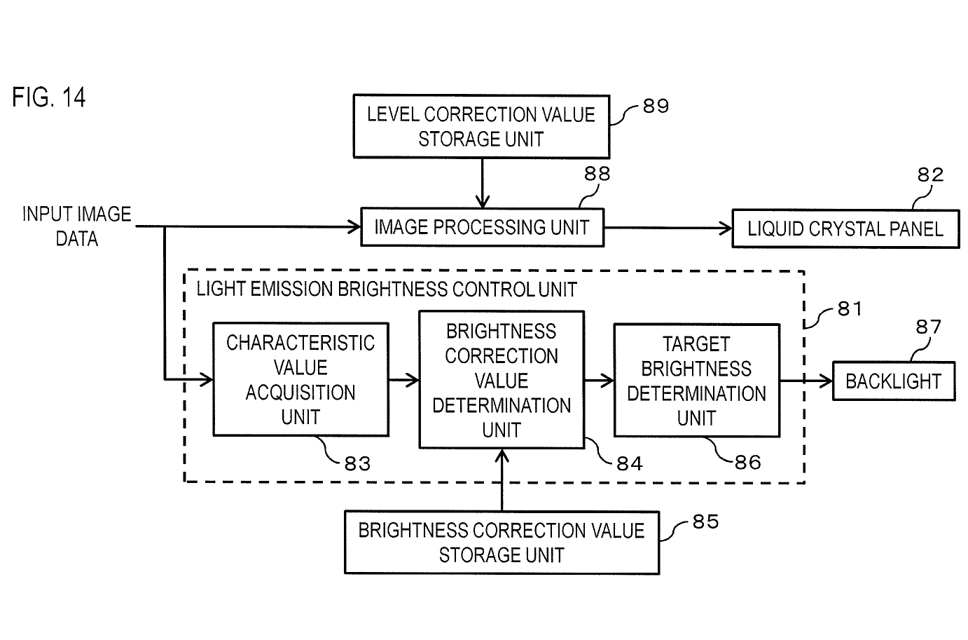

FIG. 14 is a block diagram showing one example of the functional composition of a liquid crystal display apparatus relating to a second embodiment of the present invention. As shown in FIG. 14, the liquid crystal display apparatus according to the present embodiment also has an image processing unit 88 and a level correction value storage unit 89, in addition to the functional units of the first embodiment. In the present embodiment, the input image data is not input directly to the liquid crystal panel 82, but rather is input to the liquid crystal panel 82 via the image processing unit 88.

In FIG. 14, functional units which are the same as the first embodiment are labelled with the same reference numerals, and description thereof is omitted here.

The level correction value storage unit 89 is a second storage unit in which a level correction value for correcting the gradation level of the image data so as to reduce the third brightness non-uniformity is recorded in advance. In the present embodiment, a level correction value for each combination of pixel position and uncorrected gradation level is recorded in the level correction value storage unit 89.

The level correction value recorded in the level correction value storage unit 89 is calculated by the following method, for example.

Firstly, input image data having a uniform gradation level is input to the liquid crystal panel 82, and a display image having a reduced first brightness non-uniformity and second brightness non-uniformity is obtained by a similar method to the first embodiment.

Next, the brightness distribution of the obtained display image is measured using a two-dimensional brightness measurement apparatus.

Using the measured brightness distribution, the differential between the display brightness of the pixel and the display brightness of a predetermined pixel (reference pixel), is calculated for each pixel and set as the level correction value for that pixel. The reference pixel is a pixel in the center of the screen, for example.

By carrying out the processing described above for each gradation level, it is possible to obtain a level correction value for each combination of pixel position and uncorrected gradation level.

The image processing unit 88 corrects the gradation level of the image data so as to reduce the third brightness non-uniformity. In the present embodiment, the image processing unit 88 corrects the gradation level of the image data by using the level correction value recorded in the level correction value storage unit 89. More specifically, the image processing unit 88 acquires the level correction value corresponding to the combination of the position of the pixel in the input image data, and the gradation level of the pixel, from the level correction value storage unit 89. The image processing unit 88 uses the level correction value acquired in respect of the pixel in the input image data to correct the gradation level for that pixel. In the present embodiment, the gradation level in the input image data is corrected by adding the level correction value to the gradation level in the input image data.

The image processing unit 88 outputs the image data having corrected gradation levels, to the liquid crystal panel 82.

In the present embodiment, the level correction value is a correction value that is added to the gradation level, but the invention is not limited to this. For example, the level correction value may be a correction coefficient that is multiplied by the gradation level.

In the present embodiment, the gradation level is corrected by using a previously prepared level correction value, but the invention is not limited to this. For instance, the gradation level may also be corrected by using a previously prepared function. Provided that the gradation level of the image data can be corrected so as to reduce the third brightness non-uniformity, there are no particular restrictions on the correction method.

The level correction values corresponding to each of the combinations of the pixel position and the uncorrected gradation level may be recorded in the level correction value storage unit 89, but in the case of a composition such as this, the storage capacity of the level correction value storage unit 89 becomes larger.

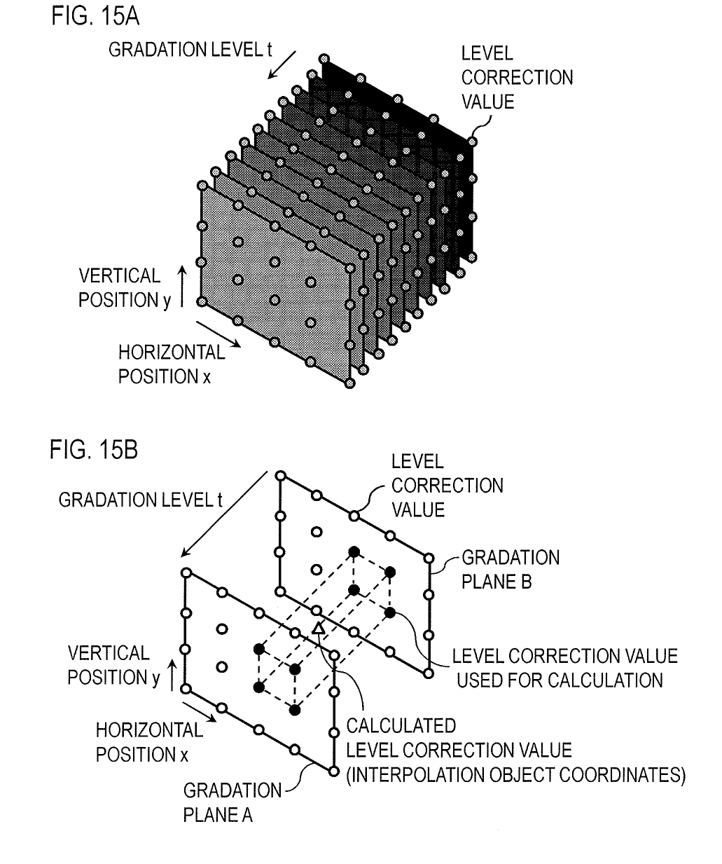

Therefore, in the present embodiment, as shown in FIG. 15A, the level correction values corresponding to each of a part of the combinations of pixel position and uncorrected gradation level are recorded in the level correction value storage unit 89. In other words, level correction values relating to discrete pixel positions and discrete gradation levels are recorded in the level correction value storage unit 89.

Then, in respect of pixels for which a corresponding level correction value has been recorded in the level correction value storage unit 89, the image processing unit corrects the gradation level by using the level correction value.

Furthermore, in respect of pixels for which a corresponding level correction value has not been recorded in the level correction value storage unit 89, the image processing unit 88 determines corresponding level correction value by interpolation using the level correction values recorded in the level correction value storage unit 89. The image processing unit 88 corrects the gradation levels using the determined level correction values.

FIG. 15B shows one example of a method for interpolating the level correction values. FIG. 15B shows a three-dimensional space based on the axes: horizontal position x of pixel, vertical position y of pixel, and uncorrected gradation level t.

In the example in FIG. 15B, eight level correction values corresponding to the eight coordinates forming the smallest region that includes the coordinates (interpolation object coordinates) corresponding to the combination of the position (x1, y1) of the pixel in the input image data and the gradation level t1, in the abovementioned three-dimensional space, are acquired. By synthesizing the acquired eight level correction values using weightings corresponding to the distances between the coordinates corresponding to the acquired level correction values and the interpolation object coordinates, level correction values corresponding to the interpolation object coordinates are calculated.

The method for interpolating the level correction values is not limited to the method described above. For example, the average value of the eight level correction values described above may be calculated as the level correction value corresponding to the interpolation object coordinates. Furthermore, the level correction value corresponding to the coordinates nearest to the interpolation object coordinates may be acquired from the level correction value storage unit 89 as a level correction value corresponding to the interpolation object coordinates. Various methods proposed in the prior art may be used as the interpolation method.

As described above, according to the present embodiment, it is possible to further reduce a third brightness non-uniformity without reducing contrast, by correcting the gradation levels of the image data. Consequently, the brightness non-uniformities can be reduced with higher accuracy than in the first embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s).

This application claims the benefit of Japanese Patent Application No. 2013-162586, filed on Aug. 5, 2013, which is hereby incorporated by reference herein in its entirety.

What is claimed is:

1. A display apparatus, comprising:
a light-emitting unit having a plurality of light sources, the light emission brightness of which can be controlled independently;
a display unit configured to display an image on a screen by modulating light from the light-emitting unit;
a first storage unit configured to store a first brightness correction value for reducing a first brightness non-uniformity of the display unit corresponding to a first gradation level, and a second brightness correction value for reducing a second brightness non-uniformity of the display unit corresponding to a second gradation level; and
a control unit configured to determine, by using the first brightness correction value and the second brightness correction value stored in the first storage unit, a brightness correction value corresponding to a gradation level of a display object image data, and control, on the basis of the determined brightness correction value, the light emission brightnesses of respective light sources.

2. The display apparatus according to claim 1, wherein the control unit:
acquires, for each of the plurality of light sources, a characteristic value representing a gradation level of an image data to be displayed on a region of a screen corresponding to the light source; and
determines a brightness correction value corresponding to the acquired characteristic value, for each light source.

3. The display apparatus according to claim 2, wherein the control unit:
determines a value which is the same as the first brightness correction value, as the brightness correction value, in respect of a light source for which a characteristic value corresponding to the first gradation level has been acquired; and
determines a value which is the same as the second brightness correction value, as the brightness correction value, in respect of a light source for which a characteristic value corresponding to the second gradation level has been acquired.

4. The display apparatus according to claim 2, wherein the control unit determines a brightness correction value between the first brightness correction value and the second brightness correction value in respect of a light source for which a characteristic value corresponding to a gradation level between the first gradation level and the second gradation level has been acquired.

5. The display apparatus according to claim 2, wherein the control unit determines a brightness correction value by synthesizing the first brightness correction value and the second brightness correction value, using a weighting based on the acquired characteristic value.

6. The display apparatus according to claim 5, wherein
the second gradation level is a gradation level that is lower than the first gradation level; and
the control unit makes the weighting of the first brightness correction value larger, the higher the gradation level represented by the acquired characteristic value becomes.

7. The display apparatus according to claim 1, wherein the control unit determines a target value of the light emission brightness for each light source by correcting a predetermined reference value using the determined brightness correction value.

8. The display apparatus according to claim 1, wherein the brightness correction value is a target value of the light emission brightness of the light source.

9. The display apparatus according to claim 1, further comprising:
a second storage unit configured to store a level correction value for reducing a third brightness non-uniformity of the display unit corresponding to a third gradation level between the first gradation level and the second gradation level; and
a correction unit configured to correct the gradation level of the display object image data, by using the level correction value stored in the second storage unit.

10. The display apparatus according to claim 9, wherein
the second storage unit stores level correction values corresponding to each of a part of combinations of a pixel position and the uncorrected gradation level; and
the control unit:
in respect of pixels for which a corresponding level correction value is stored in the second storage unit, corrects a gradation level by using the corresponding level correction value; and
in respect of pixels for which a corresponding level correction value is not stored in the second storage unit, determines a corresponding level correction value by interpolation using level correction values stored in the second storage unit, and corrects a gradation level by using the determined level correction value.

11. The display apparatus according to claim 1, wherein
the first gradation level is a maximum value of gradation level that may be used by the image data; and
the second gradation level is a minimum value of the gradation level that may be used by the image data.

12. A method for controlling a display apparatus, having:
a light-emitting unit having a plurality of light sources, the light emission brightness of which can be controlled independently;
a display unit configured to display an image on a screen by modulating light from the light-emitting unit; and
a first storage unit configured to store a first brightness correction value for reducing a first brightness non-uniformity of the display unit corresponding to a first gradation level, and a second brightness correction value for reducing a second brightness non-uniformity of the display unit corresponding to a second gradation level;
the control method comprising:
determining, by using the first brightness correction value and the second brightness correction value stored in the first storage unit, a brightness correction value corresponding to a gradation level of a display object image data; and
controlling the light emission brightnesses of respective light sources, on the basis of the determined brightness correction value.

13. A non-transitory computer readable medium that stores a program, wherein the program causes a computer to execute the method according to claim 12.
